(19) United States
(12) Patent Application Publication
(10) Pub. No.: US 2026/0128840 A1
(43) Pub. Date: May 7, 2026

(54) TYPE-1 HARQ-ACK CODEBOOK FOR A SINGLE DOWNLINK CONTROL INFORMATION SCHEDULING MULTIPLE CELLS

(71) Applicant: Telefonaktiebolaget LM Ericsson (publ), Stockholm (SE)

(72) Inventors: Sorour FALAHATI, STOCKHOLM (SE); Mattias ANDERSSON, SUNDBYBERG (SE); Ajit NIMBALKER, DUBLIN, CA (US)

(73) Assignee: Telefonaktiebolaget LM Ericsson (publ), Stockholm (SE)

(21) Appl. No.: 19/117,175

(22) PCT Filed: Sep. 29, 2023
(86) PCT No.: PCT/SE2023/050971

§ 371 Date: Mar. 31, 2025

Related U.S. Application Data
(60) Provisional application No. 63/412,100, filed on Sep. 30, 2022.

(51) Int. Cl. H04L 5/00; H04L 1/1867; H04W 72/0446; H04W 72/232

(52) U.S. Cl. CPC H04L 5/0055; H04L 1/1887; H04W 72/0446; H04W 72/232

(57) ABSTRACT

A method in a network node is provided to schedule multiple cells in a single DCI. The method includes receiving a configuration of one or more conditions for starting and/or ending of co-scheduled PDSCHs across multiple cells with a single time, including one or more of: co-scheduled PDSCHs by the single DCI are expected to end in a same UL slot corresponding to PUCCH transmission; co-scheduled PDSCHs by the single DCI are expected to start in the same UL slot corresponding to PUCCH transmission; and any co-scheduled PDSCH by the single DCI is expected to end in a UL slot corresponding to PUCCH transmission not earlier than Km UL slots prior to the UL slot associated to the PUCCH transmission with HARQ-ACK feedback corresponding to the co-scheduled PDSCHs. The method further includes scheduling co-scheduled PDSCHs in multiple cells in the single DCI in accordance with the configuration.

### TECHNICAL FIELD

The present disclosure relates generally to communications, and more particularly to communication methods and related devices and nodes supporting encoding and decoding.

### BACKGROUND

### Carrier Aggregation

Carrier Aggregation is generally used in NR (5G) and LTE (long term evolution) systems to improve UE (user equipment) transmit receive data rate. With carrier aggregation (CA), the UE typically operates initially on single serving cell called a primary cell (Pcell). The Pcell is operated on a component carrier in a frequency band. The UE is then configured by the network with one or more secondary serving cells (Scell(s)). Each Scell can correspond to a component carrier (CC) in the same frequency band (intra-band CA) or different frequency band (inter-band CA) from the frequency band of the CC corresponding to the Pcell. For the UE to transmit/receive data on the Scell(s) (e.g., by receiving DL-SCH information on a PDSCH or by transmitting UL-SCH on a PUSCH), the Scell(s) need to be activated by the network. The Scell(s) can also be deactivated and later reactivated as needed via activation/deactivation signaling.

### Cross-Carrier Scheduling

For NR carrier aggregation, cross-carrier scheduling (CCS) has been specified using the following framework:
1. UE has a primary serving cell and can be configured with one or more secondary serving cells (SCells)
2. For a given SCell with Scell index X,
   a. if the SCell is configured with a ‘scheduling cell’ with cell index Y (cross-carrier scheduling)
      i. SCell X is referred to as the ‘scheduled cell’
      ii. UE monitors DL PDCCH on the scheduling cell Y for assignments/grants scheduling PDSCH/PUSCH corresponding to Sell X.
      iii. PDSCH/PUSCH corresponding to Sell X cannot be scheduled for the UE using a serving cell other than scheduling cell Y
   b. Otherwise
      i. SCell X is the scheduling cell for SCell X (same-carrier scheduling)
      ii. UE monitors DL PDCCH on SCell X for assignments/grants scheduling PDSCH/PUSCH corresponding to Sell X
      iii. PDSCH/PUSCH corresponding to Sell X cannot be scheduled for the UE using a serving cell other than SCell X
3. An SCell cannot be configured as a scheduling cell for the primary cell. The primary cell is always its own scheduling cell.

### Dual Connectivity

Dual Connectivity (DC) is generally used in NR (5G) and LTE systems to improve UE transmit receive data rate. With DC, the UE typically operates a master cell group (MCG) and a secondary cell group (SCG). Each cell group can have one or more serving cells. The MCG cell, operating on the primary frequency, in which the UE either performs the initial connection establishment procedure or initiates the connection re-establishment procedure is referred to as the primary cell or PCell. The SCG cell in which the UE performs random access when performing the Reconfiguration with Sync procedure is referred to as the primary SCG cell or PSCell.

In some cases, the term “primary cell” or “primary serving cell” can refer to PCell for a UE not configured with DC, and can refer to PCell of MCG or PSCell of SCG for a UE configured with DC.

### PDCCH Monitoring

In 3GPP NR standard, downlink control information (DCI) is received over the physical layer downlink control channel (PDCCH). The PDCCH may carry DCI in messages with different formats. DCI format 0_0 and 0_1 are DCI messages used to convey uplink grants to the UE for transmission of the physical uplink shared channel (PUSCH) and DCI format 1_0 and 1_1 are used to convey downlink grants for transmission of the physical downlink shared channel (PDSCH). Other DCI formats (2_0, 2_1, 2_2 and 2_3) are used for other purposes such as transmission of slot format information, reserved resource, transmit power control information etc.

A PDCCH candidate is searched within a common or UE-specific search space which is mapped to a set of time and frequency resources referred to as a control resource set (CORESET). The search spaces within which PDCCH candidates must be monitored are configured to the UE via radio resource control (RRC) signaling. A monitoring periodicity is also configured for different PDCCH candidates. In any particular slot the UE may be configured to monitor multiple PDCCH candidates in multiple search spaces which may be mapped to one or more CORESETs. PDCCH candidates may need to be monitored multiple times in a slot, once every slot or once in multiple of slots.

The smallest unit used for defining CORESETs is a Resource Element Group (REG) which is defined as spanning 1 PRB×1 OFDM symbol in frequency and time. Each REG contains demodulation reference signals (DM-RS) to aid in the estimation of the radio channel over which that REG was transmitted. When transmitting the PDCCH, a precoder could be used to apply weights at the transmit antennas based on some knowledge of the radio channel prior to transmission. It is possible to improve channel estimation performance at the UE by estimating the channel over multiple REGs that are proximate in time and frequency if the precoder used at the transmitter for the REGs is not different. To assist the UE with channel estimation, the multiple REGs can be grouped together to form a REG bundle and the REG bundle size for a CORESET is indicated to the UE. The UE may assume that any precoder used for the transmission of the PDCCH is the same for all the REGs in the REG bundle. A REG bundle may consist of 2, 3 or 6 REGs.

A control channel element (CCE) consists of 6 REGs. The REGs within a CCE may either be contiguous or distributed in frequency. When the REGs are distributed in frequency, the CORESET is said to be using an interleaved mapping of REGs to a CCE and if the REGs are not distributed in frequency, a non-interleaved mapping is said to be used.

A PDCCH candidate may span 1, 2, 4, 8 or 16 CCEs. The number of aggregated CCEs used is referred to as the aggregation level for the PDCCH candidate.

### Time Domain Resource Allocation

A UE shall determine the time domain allocation for a PUSCH or PDSCH using the time domain resource allocation (TDRA) field in the detected DCI carried in PDCCH. The TDRA field value is used to look up a TDRA entry in a TDRA table. One or more TDRA tables can be configured by higher layers (or pre-defined in specification) per scheduling cell consisting of a list with one or more TDRA entries in it. Each TDRA entry has a slot offset (k0), a SLIV (Start and length indicator value). PDSCH mapping type (A or B) and DMRS type A position and/or repetition factor. The offset (in slots) between the slot where the DCI is detected and the slot where the corresponding PDSCH is received is based on the slot offset. The SLIV denotes the start symbol and length of PDSCH (in symbols) in the corresponding slot.

### HARQ (Hybrid Automatic Repeat Request) Feedback

The procedure for receiving downlink transmission is that the UE first monitors and decodes a PDCCH in downlink slot m which points to a DL (downlink) data scheduled in slot m+k₀ slots (k₀ is larger than or equal to 0). The UE then decodes the data in the corresponding PDSCH. Finally based on the outcome of the decoding the UE sends an acknowledgement of the correct decoding (ACK) or a negative acknowledgement (NACK) in a PUCCH transmission to the gNB at uplink slot n++k₁ where slot n is the UL (uplink) slot that overlaps with the DL slot where the corresponding PDSCHs (in case of PDSCH repetition, when the corresponding PDSCH repetition ends), k1 is determined from the field in DCI PDSCH to HARQ-ACK that provides an index to a set of configured or default k1 values (set K1). The PUCCH resource for sending the acknowledgement is indicated by PUCCH resource indicator (PRI) field in the DCI which points to one of PUCCH resources that are configured by higher layers or provided by default.

Depending on DL/UL slot configurations, or whether carrier aggregation, or per code-block group (CBG) transmission used in the DL, the feedback for several PDSCHs may need to be multiplexed in one feedback. This is done by constructing HARQ-ACK codebooks. In NR, the UE can be configured to multiplex the A/N bits using a semi-static (Type-1) codebook or a dynamic (Type-2) codebook. Semi-static HARQ-ACK codebook is robust due to its fixed size, at the cost of additional overhead since regardless of whether there is a transmission or not a bit is reserved in the HARQ-ACK codebook. Dynamic HARQ-ACK codebook avoids reserving unnecessary bits as in a semi-static HARQ codebook, where an A/N bit is present only if there is a corresponding transmission scheduled and relies on downlink assignment indicator (DAI) mechanism to avoid misalignments between the UE and gNB on codebook size.

FIG. 1 illustrates the timeline in a simple scenario with two PDSCHs and one feedback. In this example there is in total 4 PUCCH resources configured, and the PRI indicates PUCCH 2 to be used for HARQ feedback.

In NR Rel-15, a UE can be configured with maximum 4 PUCCH resource sets for transmission of HARQ-ACK information. Each set is associated with a range of UCI (uplink control information) payload bits including HARQ-ACK bits. The first set is always associated to 1 or 2 HARQ-ACK bits and hence includes only PUCCH format 0) or 1 or both. The range of payload values (minimum of maximum values) for other sets, if configured, is provided by configuration except the maximum value for the last set where a default value is used, and the minimum value of the second set being 3. The first set can include maximum 32 PUCCH resources of PUCCH format 0 or 1. Other sets can include maximum 8 bits of format 2 or 3 or 4.

As described previously, the UE determines a slot for transmission of HARQ-ACK bits in a PUCCH corresponding to PDSCHs scheduled or activated by DCI via K₁ value provided by configuration or a field in the corresponding DCI. The UE forms a codebook from the HARQ-ACK bits with associated PUCCH in a same slot via corresponding K₁ values.

The UE determines a PUCCH resource set that the size of the codebook is within the corresponding range of payload values associated to that set.

The UE determines a PUCCH resource in that set if the set is configured with maximum 8 PUCCH resources, by a field in the last DCI associated to the corresponding PDSCHs. If the set is the first set and is configured with more than 8 resources, a PUCCH resource in that set is determined by a field in the last DCI associated to the corresponding PDSCHs and implicit rules based on the CCE.

A PUCCH resource for HARQ-ACK transmission can overlap in time with other PUCCH resources for CSI and/or SR transmissions as well as PUSCH transmissions in a slot. In case of overlapping PUCCH and/or PUSCH resources, first the UE resolves overlapping between PUCCH resources, if any, by determining a PUCCH resource carrying the total UCI (including HARQ-ACK bits) such that the UCI multiplexing timeline requirements are met. There might be partial or completely dropping of CSI bits, if any, to multiplex the UCI in the determined PUCCH resource. Then, the UE resolves overlapping between PUCCH and PUSCH resources, if any, by multiplexing the UCI on the PUSCH resource if the timeline requirements for UCI multiplexing is met.

### Sub-Slot HARQ-ACK

In NR Rel-16, an enhancement on HARQ-ACK feedback is made to support more than one PUCCH carrying HARQ-ACK in a slot for supporting different services and for possible fast HARQ-ACK feedback for URLLC. This leads to an introduction of new HARQ-ACK timing in a unit of sub-slot, i.e., K1 indication in a unit of sub-slot. Sub-slot configurations for PUCCH carrying HARQ-ACK can be configured from the two options, namely “2-symbol*7” and “7-symbol*2” for the sub-slot length of 2 symbols and 7 symbols, respectively. The indication of K1 is the same as that of Rel-15, that is, K1 is indicated in the DCI scheduling PDSCH. To determine the HARQ-ACK timing, there exists an association of PDSCH to sub-slot configuration in that if the scheduled PDSCH ends in sub-slot n, the corresponding HARQ-ACK is reported in sub-slot n+K1. In a sense, sub-slot based HARQ-ACK timing works similarly to that of Rel-15 slot-based procedure by replacing the unit of K1 from slot to sub-slot. There exist some limitations on PUCCH resources for sub-slot HARQ-ACK. That is, only one PUCCH resource configuration is used for all sub-slots in a slot. Moreover, any PUCCH resource for sub-slot HARQ-ACK cannot cross sub-slot boundaries.

FIG. 2 shows an example where each PDSCH is associated with a certain sub-slot for HARQ feedback through the use of a K1 value in units of sub-slots.

### Semi-Static (Type-1) HARQ Codebook

Type 1 or semi-static codebook consists of a bit sequence where each element contains the A/N bit from a possible allocation in a certain slot, carrier, or transport block (TB). When the UE is configured with code block group (CBG) and/or time-domain resource allocation (TDRA) table with multiple entries, multiple bits are generated per slot and TB (see below). It is important to note that the codebook is derived regardless of the actual PDSCH scheduling. The size and format of the semi-static codebook is preconfigured based on the mentioned parameters. The draw back of semi-static HARQ ACK codebook is that the size is fixed, and regardless of whether there is a transmission or not a bit is reserved in the feedback matrix.

On the case when a UE has a TDRA table with multiple time-domain resource allocation entries configured: The table is pruned (i.e., entries are removed based on a specified algorithm) to derive a TDRA table that only contains non-overlapping time-domain allocations. One bit is then reserved in the HARQ CB for each non-overlapping entry (assuming a UE is capable of supporting reception of multiple PDSCH in a slot).

HARQ codebook size in time (DL association set) is determined based on the configured (or default) set of HARQ-ACK timings K1, and semi-static configured TDD pattern
If UE supports reception of more than one unicast PDSCH per slot, one HARQ codebook entry for each non-overlapping time-domain resource allocation in the pdsch-symbolAllocation table is reserved per slot: otherwise one HARQ entry is reserved per slot.
If a PDSCH is part of multiple HARQ association sets it is acknowledged in the HARQ codebook indicated by slot timing indicator K1, and NACKed in the other codebooks

In component carrier dimension HARQ codebook size is given by configured number of DL cells and the max number of HARQ-ACK feedback bits based on configuration per DL cell (MIMO, spatial bundling, configured number of code block groups (CBGs) per TB).

FIG. 3 is an illustration of a configured slot timing indicator K1 is 1 to 5->HARQ codebook size in time 5 not considering impact from pdsch-symbolAllocation and TDD pattern). X is placeholder for ACK or NACK depending on decoding outcome. Fixed NACK (N) is filled in for PDSCH entries not acknowledged in this HARQ CB.

FIG. 4 is an example of a UE configured with 3 cells (cell 1:2 TB, cell 2:1 TB, cell 3:1 TB with 4 CBG).

### Dynamic (Type-2) HARQ Codebook

In type 2 or dynamic HARQ codebook, an A/N bit is present in a codebook only if there is a corresponding transmission scheduled. To avoid any confusion between the gNB and the UE, on the number of PDSCHs that the UE has to send a feedback for, a counter downlink assignment indicator (DAI) field exists in DL assignment, which denotes accumulative number of {serving cell, PDCCH occasion} pairs in which a PDSCH is scheduled to a UE up to the current PDCCH. In addition to that, there is another field called total DAI, which when present shows the total number of {serving cell, PDCCH occasion} up to (and including) all PDCCHs of the current PDCCH monitoring occasion. The timing for sending HARQ feedback is determined based on both PDSCH transmission slot with reference to PDCCH slot (K₀) and the PUCCH slot that contains HARQ feedback (K₁).

### HARQ-ACK Multiplexing in PUSCH

When HARQ-ACK multiplexing on a PUSCH in case of overlapping between the PUSCH resource and the PUCCH resource with the HARQ-ACK information, the physical resources for HARQ-ACK bits based on the following formula will be calculated as the following:

$$\begin{matrix}{Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{c}_{UL - SCH} - 1} {K}_{r}} ⌉ , ⌈ α \cdot {{\sum }^{{N}_{symb , all}^{PUSCH}}}_{l = {l}_{0}} ⌉ \} \\ where {Q}_{ACK}^{′}\end{matrix}$$

is the number of coded modulation symbols per layer for HARQ-ACK transmission, O_{ACK} is the number of HARQ-ACK bits,

$${β}_{offset}^{PUSCH}$$

is configured by high layer parameters,

$${M}_{sc}^{UCI} ( l )$$

is the number of resource elements that can be used for transmission of UCI in OFDM symbol l, for l=0, 1, 2, . . . ,

$${N}_{symb , all}^{PUSCH} = 1 ,$$

in the PUSCH transmission and

$${N}_{symb , all}^{PUSCH}$$

is the total number of OFDM symbols of the PUSCH, including all OFDM symbols used for DMRS, α is configured by higher layer parameter scaling.

Then it will do rate-matching for HARQ-ACK and UL-SCH bits. There are two cases. The first case is HARQ-ACK is less than or equal to 2 bits, the second case is HARQ-ACK is more than 2 bits. When HARQ-ACK bits is less than or equal to 2 bits, the HARQ-ACK bits will puncture the UL-SCH coded bits. When HARQ-ACK bits is more than 2 bits, the rate matching of UL-SCH coded bits will be impacted by HARQ-ACK bits. Considering the following example. UL-SCH and HARQ-ACK bits multiplexing in one slot including 144 REs for UL-SCH and HARQ-bits and using QPSK for transmission, HARQ-ACK bits equal to 3 and

$${β}_{offset}^{PUSCH} = 5 , then the {Q}_{ACK}^{′} = 27 ,$$

the coded HARQ-ACK bits is 54 bits, when do rate-matching for UL-SCH, there will be 234 UL-SCH coded bits.

Considering that the UCI bits can only transmit in one slot, the maximum HARQ-ACK coded bits is limited. Also, when HARQ-ACK bits are too large, the performance of UL-SCH will be impacted.

When HARQ-ACK transmit in PUCCH, it can use different PUCCH format. UE shall determine the PUCCH resource set and resource based on dedicated resource configuration or the PUCCH configuration table in 3GPP TS 38.213.

For PUCCH format 0/1, it can only transmit HARQ-ACK bits no more than 2 bits. For PUCCH format 0, UE shall select orthogonal sequence based on HARQ-ACK bits and do physical resource mapping.

For PUCCH format 1, the HARQ-ACK bits will be modulated, multiply frequency sequence and block-wise spread with orthogonal sequence.

For PUCCH format 2/3/4, the HARQ-ACK bits will be encoded firstly, UE shall do rate matching for HARQ-ACK bits and other UCI bits based on the following table.

| | Modulation order | |
|---|---|---|
| PUCCH format | QPSK | π/2-BPSK |
| PUCCH format 2 | $16 \cdot {N}_{symb , U C I}^{P U C C H , 2} \cdot {N}_{P R B}^{P UCCH , 2}$ | N/A |
| PUCCH format 3 | $24 \cdot {N}_{symb , U C I}^{P U C CH , 3} \cdot {N}_{P R B}^{PUCCH , 3}$ | $12 \cdot {N}_{symb , U C I}^{P U C CH , 3} \cdot {N}_{P R B}^{PUCCH , 3}$ |
| PUCCH format 4 | $24 \cdot {N}_{symb , U C I}^{P U C CH , 4} / {N}_{SF}^{PUCCH , 4}$ | $12 \cdot {N}_{symb , U C I}^{P U CCH , 4} / {N}_{SF}^{PUCCH , 4}$ |

Where the Eₜₒₜ is the total rate matching output sequence length,

$${N}_{symb , UCI}^{PUCCH , 2} and {N}_{symb , UCI}^{PUCCH , 3} ,$$

and

$${N}_{symb , UCI}^{PUSCH , 4}$$

are the number of symbols carrying UCI for PUCCH formats 2/3/4 respectively;

$${N}_{PRB}^{PUCCH , 2} and {N}_{PRB}^{PUCCH , 3}$$

are the number of PRBs that are determined by the UE for PUCCH formats 2/3 transmission respectively and

$${N}_{SF}^{PUCCH , 4}$$

is tie spreading factor for PUCCH format 4. Then HARQ-ACK coded bits will be modulated. After getting the symbols for the HARQ-ACK in PUCCH format 1/2/3/4, UE shall do physical resource mapping.

### Single DCI Scheduling Multiple PDSCHs/PUSCHs on Multiple Cells

In Rel-18 there is a work item on scheduling several PUSCH or PDSCH carriers using a single DCI, which is referred to as multi-carrier-DCI (MC-DCI or mc-DCI) or a single DCI scheduling multiple cells. The details of the DCI design (also refer to as DCI 1_X or DCI 0_X for scheduling PDSCHs or PUSCHs, respectively), is under discussion.

With respect to HARQ-ACK transmission for scheduled PDSCHs by DCI 1_x, the following is agreed to determine the timing of PCCH resource.
When UE detects a DCI format 1_X scheduling a set of PDSCHs, the UE provides corresponding HARQ-ACK information in a PUCCH transmission within UL slot n+k, where k is a number of slots and is indicated by the PDSCH-to-HARQ_feedback timing indicator field in the DCI format and n is the last UL slot overlapping with the DL slot n D for the reference PDSCH reception for slot-based PUCCH or an UL slot overlapping with the end of the reference PDSCH reception in DL slot for sub-slot based PUCCH.
FFS (for future study) details of reference PDSCH

To be consistent with the legacy behavior, it is reasonable to assume that the reference PDSCH is the PDSCH that ends last. This assumption is consistent with legacy behavior in case of multiple PDSCHs on a cell in case of PDSCH repetition or multi-PDSCH scheduling in case of FR2-2 where the indicated kl value would correspond to the last PDSCH.

### SUMMARY

There currently exist certain challenge(s). When a single DCI schedules multiple PDSCHs across cells, the co-scheduled PDSCHs may not be aligned in starting and/or ending time. This may cause problem when Type-1 HARQ-ACK codebook is applied for reporting HARQ-ACK feedback. The HARQ-ACK information corresponding to the co-scheduled PDSCHs is transmitted in a PUCCH in UL slot nᵤ. If a co-scheduled PDSCH (or its repetition) ends in a UL slot nₑ such that nᵤ−nₑ>max (K₁), its corresponding HARQ-ACK information cannot be reported in a Type-1 HARQ-ACK codebook. Note that the indicated kl value in the DCI associates to the reference PDSCH among the co-scheduled PDSCHs.

Certain aspects of the disclosure and their embodiments may provide solutions to these or other challenges. Various embodiments enable the support of Type-1 HARQ-ACK codebook when multiple PDSCHs scheduled across cells by a single DCI irrespective of alignment of the co-scheduled PDSCHs. The methods use the properties of multiple PDSCHs scheduled across cells by a single DCI as well as legacy procedures to construct Type-1 HARQ-ACK codebook to ensure any co-scheduled PDSCH would have a place holder for its corresponding HARQ-ACK feedback in the codebook.

In some embodiments, a method in a network node is provided to schedule multiple cells in a single DCI. The method includes receiving a configuration of one or more conditions for starting and/or ending of co-scheduled PDSCHs across multiple cells with a single time. The one or more conditions include one or more of: co-scheduled PDSCHs by the single DCI are expected to end in a same UL slot corresponding to PUCCH transmission: co-scheduled PDSCHs by the single DCI are expected to start in the same UL slot corresponding to PUCCH transmission; and any co-scheduled PDSCH by the single DCI is expected to end in a UL slot corresponding to PUCCH transmission not earlier than Km UL slots prior to the UL slot associated to the PUCCH transmission with HARQ-ACK feedback corresponding to the co-scheduled PDSCHs. The method further includes scheduling co-scheduled PDSCHs in multiple cells in the single DCI in accordance with the configuration.

In other embodiments, a method in a network node is provided to schedule multiple cells in a single DCI. The method includes obtaining an extended set of K1 values. Kext, for determining a set of M_{A,c} candidate PDSCH reception occasions for a cell c among the configured cells for single DCI scheduling multiple cells for Type-1 HARQ-ACK codebook. The method further includes scheduling co-scheduled PDSCHs in multiple cells in the single DCI.

In still other embodiments, a method in a network node is provided to schedule multiple cells in a single DCI. The method includes, when a single DCI schedules multiple PDSCHs across cells, receiving the HARQ-ACK information corresponding to co-scheduled PDSCHs in a PUCCH, in UL slot nᵤ. The method further includes determining, for every scheduled cell c, the co-scheduled PDSCH, outer PDSCH, that ends in a UL slot n_{e,c} such that nᵤ−n_{e,c}>max (K1); and scheduling co-scheduled PDSCHs in multiple cells in the single DCI.

In some embodiments, a network node is provided that is configured to communicate with a base station. The network node includes a radio interface and processing circuitry configured to perform operations. The operations include to receive a configuration of one or more conditions for starting and/or ending of co-scheduled PDSCHs across multiple cells with a single time. The one or more conditions include one or more of: co-scheduled PDSCHs by the single DCI are expected to end in a same UL slot corresponding to PUCCH transmission: co-scheduled PDSCHs by the single DCI are expected to start in the same UL slot corresponding to PUCCH transmission; and any co-scheduled PDSCH by the single DCI is expected to end in a UL slot corresponding to PUCCH transmission not earlier than Km UL slots prior to the UL slot associated to the PUCCH transmission with HARQ-ACK feedback corresponding to the co-scheduled PDSCHs. The operations further include to schedule co-scheduled PDSCHs in multiple cells in the single DCI in accordance with the configuration.

In other embodiments, a method is provided that is implemented by a host configured to operate in a communication system that further includes a network node, and a UE. The method includes providing user data for the UE; and initiating transmissions carrying the user data to the UE via a cellular network comprising the network node. The network node performs operations to transmit the user data from the host to the UE. The operations include to receive a configuration of one or more conditions for starting and/or ending of co-scheduled PDSCHs across multiple cells with a single time. The one or more conditions include one or more of: co-scheduled PDSCHs by the single DCI are expected to end in a same UL slot corresponding to PUCCH transmission: co-scheduled PDSCHs by the single DCI are expected to start in the same UL slot corresponding to PUCCH transmission; and any co-scheduled PDSCH by the single DCI is expected to end in a UL slot corresponding to PUCCH transmission not earlier than Km UL slots prior to the UL slot associated to the PUCCH transmission with HARQ-ACK feedback corresponding to the co-scheduled PDSCHs. The operations further include to schedule co-scheduled PDSCHs in multiple cells in the single DCI in accordance with the configuration.

In yet other embodiments, a host configured to operate in a communication system to provide an over-the-top, OTT, service is provided. The host includes processing circuitry configured to provide user data; and a network interface configured to initiate transmissions of the user data to a network node in a cellular network for transmission to UEs. The network node has a communication interface and processing circuitry. The processing circuitry of the network node is configured to perform operations to transmit the user data from the host to the UE. The operations include to receive a configuration of one or more conditions for starting and/or ending of co-scheduled PDSCHs across multiple cells with a single time. The one or more conditions include one or more of: co-scheduled PDSCHs by the single DCI are expected to end in a same UL slot corresponding to PUCCH transmission: co-scheduled PDSCHs by the single DCI are expected to start in the same UL slot corresponding to PUCCH transmission; and any co-scheduled PDSCH by the single DCI is expected to end in a UL slot corresponding to PUCCH transmission not earlier than Km UL slots prior to the UL slot associated to the PUCCH transmission with HARQ-ACK feedback corresponding to the co-scheduled PDSCHs. The operations further include to schedule co-scheduled PDSCHs in multiple cells in the single DCI in accordance with the configuration.

Certain embodiments may provide one or more of the following technical advantage(s). Various embodiments facilitate support of Type-1 HARQ-ACK codebook when a single DCI scheduling multiple cells is applied.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of an example of a transmission timeline;

FIG. 2 is an illustration of K1 indication based on sub-slots with “7-symbol*2” for 2 PUCCHs in two sub-slots that carry the HARQ feedback of PDSCH transmissions:

FIG. 3 is an illustration of a configured slot timing indicator K1 is 1 to 5

FIG. 4 is an illustration of an example of a UE configures with 3 cells.

FIG. 5 is an illustration where PDSCHs on different cells are scheduled with respective DCIs:

FIGS. 6 to 9 are illustrations of examples of single DCI scheduling multiple PDSCHs across cells.

FIG. 10-17 are flow charts illustrating operations of a network node according to some embodiments:

FIG. 18 is a block diagram of a communication system in accordance with some embodiments:

FIG. 19 is a block diagram of a user equipment in accordance with some embodiments:

FIG. 20 is a block diagram of a network node in accordance with some embodiments:

FIG. 21 is a block diagram of a host computer communicating with a user equipment in accordance with some embodiments:

FIG. 22 is a block diagram of a virtualization environment in accordance with some embodiments; and

FIG. 23 is a block diagram of a host computer communicating via a base station with a user equipment over a partially wireless connection in accordance with some embodiments in accordance with some embodiments.

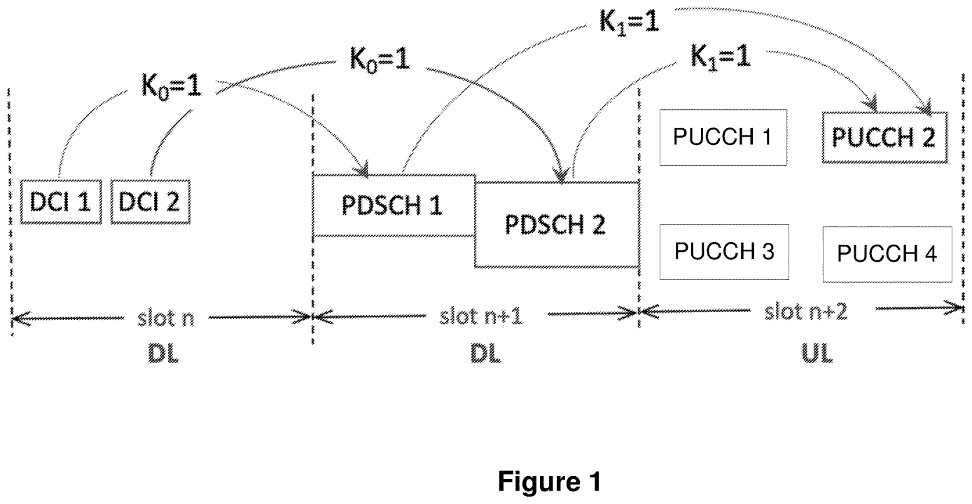

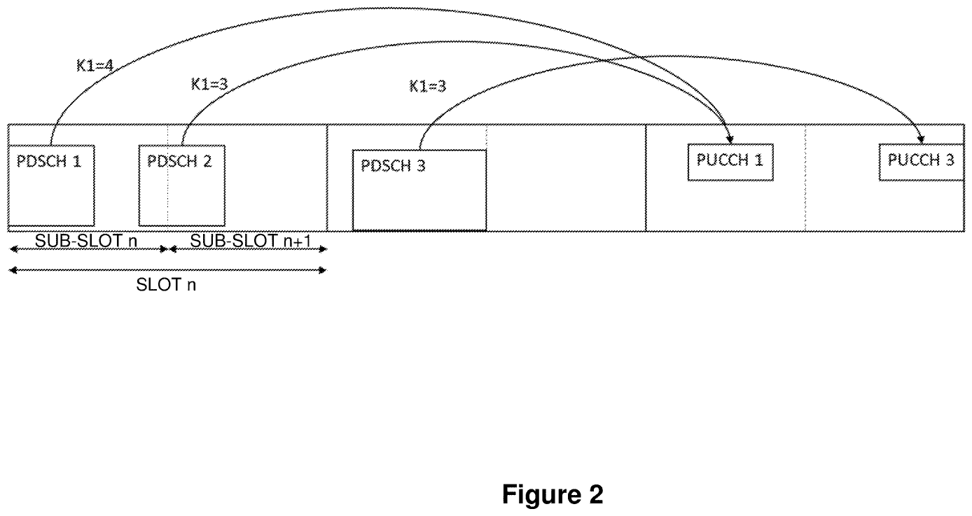

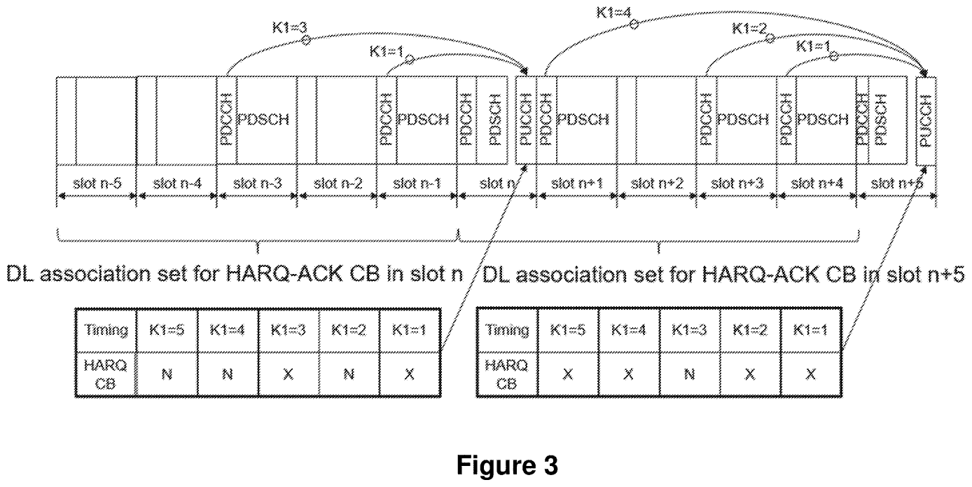

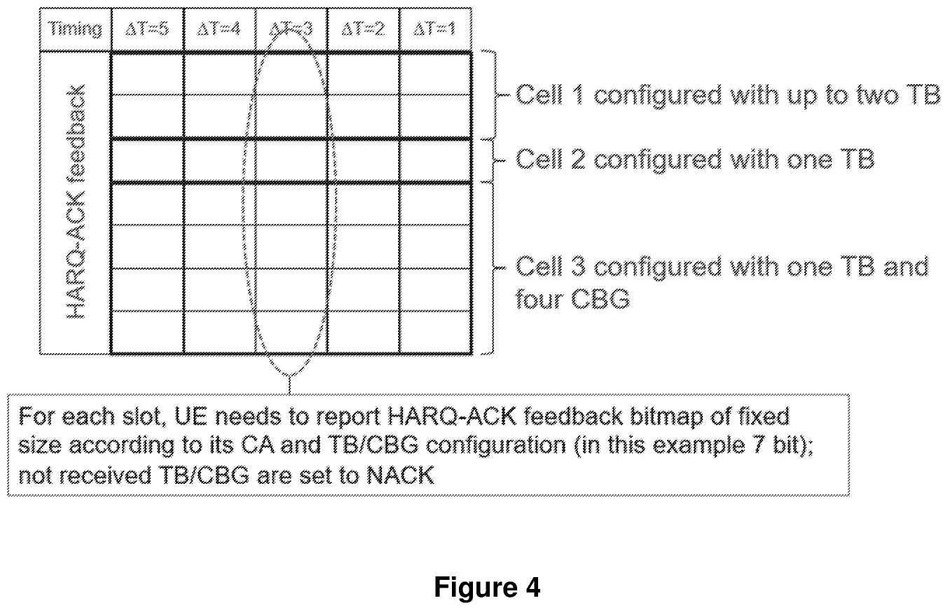

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The methods are applicable for cells with same or different subcarrier spacing, as well as slot or sub-slot configurations of PUCCH slots as well as same or different physical layer priority associated to transmissions. The methods below are applicable to the cells in a same PUCCH group. The methods are applicable to any PUCCH group in case of multiple PUCCH groups.

Additional information may also be found in the document(s) provided in the Appendix that is part of this specification.

As previously indicated, when a single DCI schedules multiple PDSCHs across cells, the co-scheduled PDSCHs may not be aligned in starting and/or ending time, which may cause issues when Type-1 HARQ-ACK codebook is applied for reporting HARQ-ACK feedback. The HARQ-ACK information corresponding to the co-scheduled PDSCHs is transmitted in a PUCCH in UL slot nᵤ. If a co-scheduled PDSCH (or its repetition) ends in a UL slot nₑ such that nᵤ−nₑ>max (K₁), its corresponding HARQ-ACK information cannot be reported in a Type-1 HARQ-ACK codebook. Note that the indicated kl value in the DCI associates to the reference PDSCH among the co-scheduled PDSCHs.

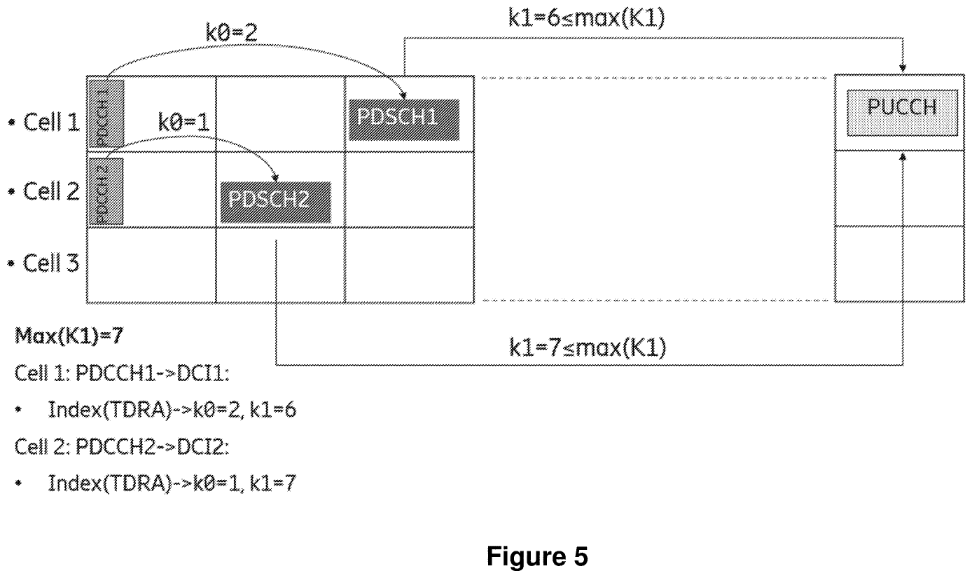

See the examples in FIG. 5 to FIG. 9. The same sub-carrier spacing for UL and DL slots are assumed to simplify the descriptions. It is assumed that Type-1 HARQ-ACK codebook is applied. The example in FIG. 5 is used as the reference for legacy behavior that illustrates the case where PDSCHs on different cells are scheduled with respective DCIs, that is there is not a single DCI scheduling multiple PDSCHs across cells. Since the applied kl value for each PDSCH is indicated by its corresponding scheduling DCI, it would be by definition a value from the set of configured/default K1 values and consequently, there would a placeholder in the codebook for its corresponding HARQ-ACK codebook, following the existing procedures for Type-1 HARQ-ACK codebook generation.

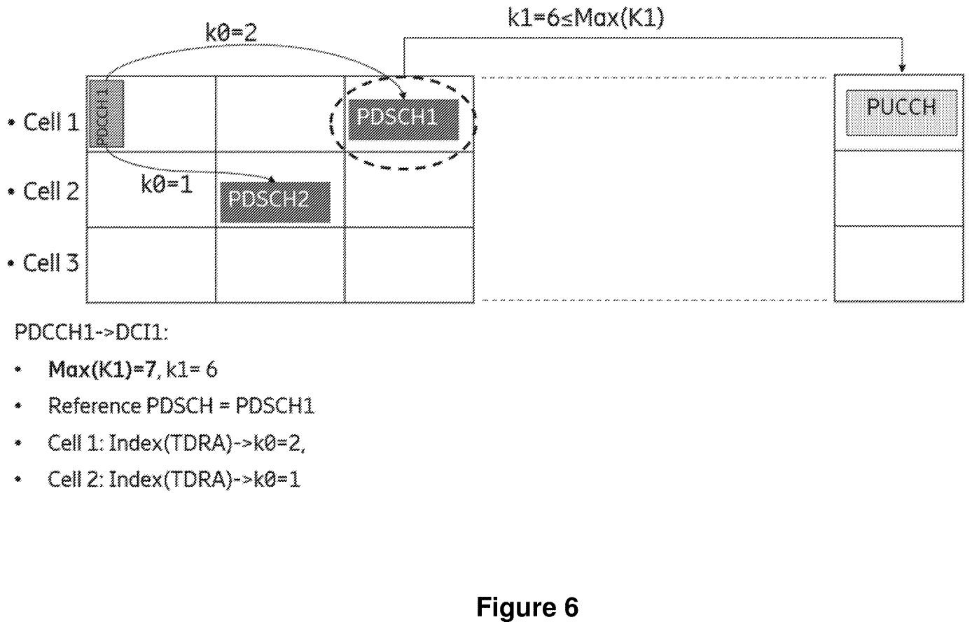

FIG. 6 to FIG. 9 show examples of single DCI scheduling multiple PDSCHs across cells.

For the example illustrated in FIG. 6, the reference PDSCH is the latest one, i.e., PDSCH1. The indicated kl value in the single DCI is applied for the reference PDSCH, i.e., PDSCH1 to determine the timing of the corresponding PUCCH for the HARQ-ACK information of PDSCH1 and PDSCH2, scheduled by DCII in PDDCH1. One can clearly observe that the existing procedures for codebook construction can easily reused since PDSCH1 and PDSCH2 would correspond to k1-6 and k1=7 as if they had been scheduled by respective DCI as in the previous example. K1=7 for PDSCH2 is a valid kl in a sense that would result in a place in the Type-1 codebook since it does not exceed maximum kl value, being 7.

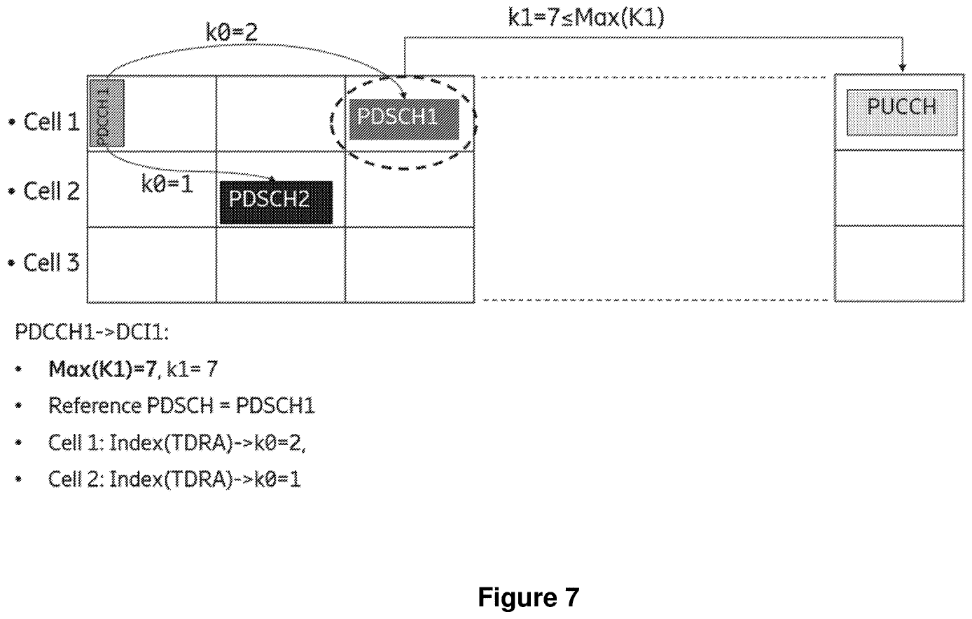

In the example illustrated in FIG. 7, the reference PDSCH is PDSCH1 and the indicated kl value by DCI is k1=7. It can be clearly observed that the indicated kl value results in assuming k1=8 for PDSCH2 which is invalid in the sense that exceeds that maximum K1 values and hence, would not correspond to a place in the Type-1 codebook. Hence, the HARQ-ACK feedback of PDSCH2 cannot be transmitted.

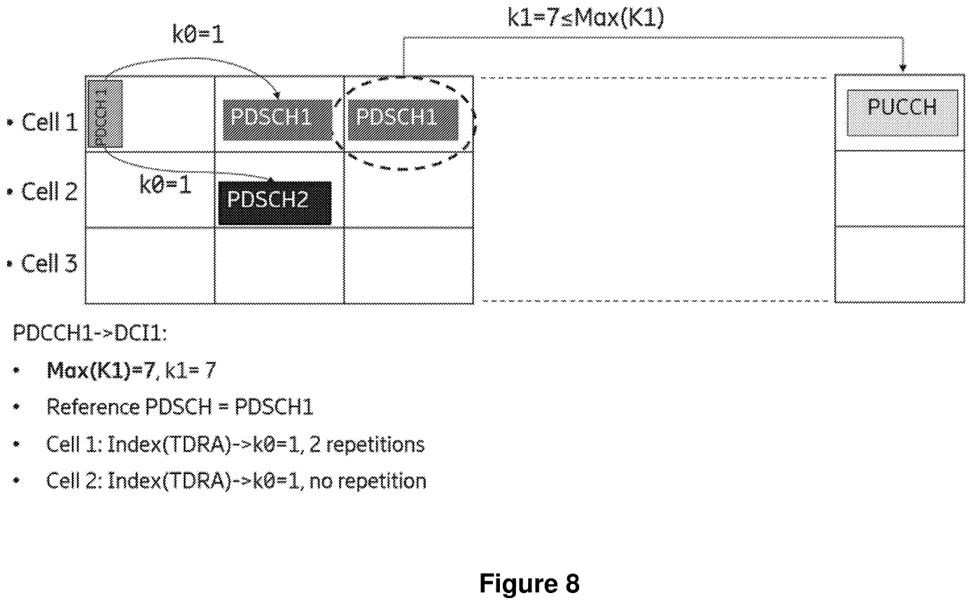

In the example illustrated in FIG. 8. PDSCH1 and PDSCH2 are aligned in starting time but PDSCH1 is indicated with repetition obtained from its indicated TDRA. The reference PDSCH, is the last repetition PDSCH1. The indicated kl value by DCI is k1=7. It can be clearly observed that the indicated kl value results in assuming k1=8 for PDSCH2 which is invalid in the sense that exceeds that maximum K1 values and hence, would not correspond to a place in the Type-1 codebook. Hence, the HARQ-ACK feedback of PDSCH2 cannot be transmitted.

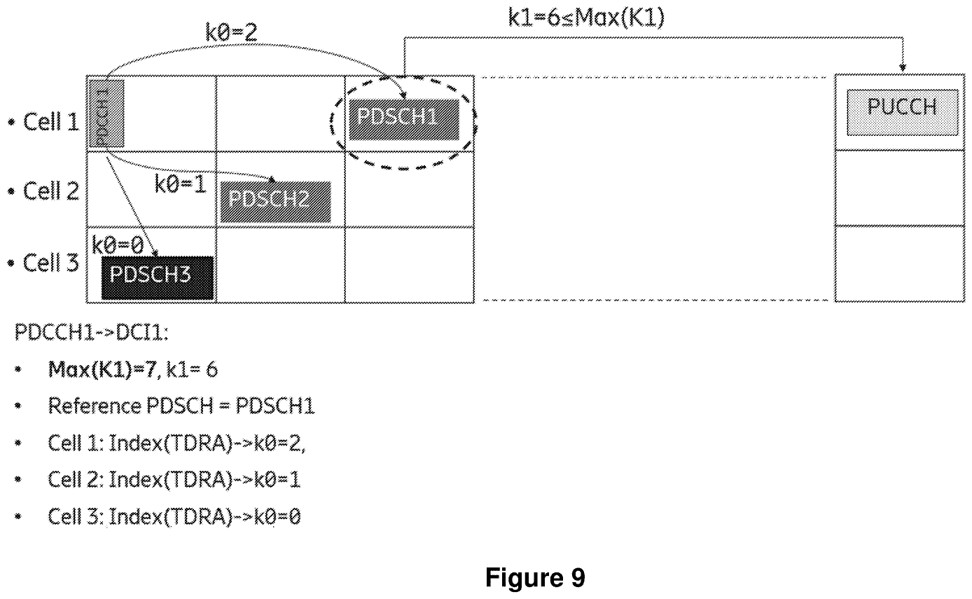

In the example illustrated in FIG. 9, the reference PDSCH is PDSCH1 and the indicated kl value by DCI is k1=6 (i.e., less than maximum K1 value). It can be clearly observed that the indication results in assuming k1=7 for PDSCH2, but k1=8 for PDSCH3 which is invalid in the sense that exceeds that maximum K1 values and hence, would not correspond to a place in the Type-1 codebook. Hence, the HARQ-ACK feedback of PDSCH3 cannot be transmitted.

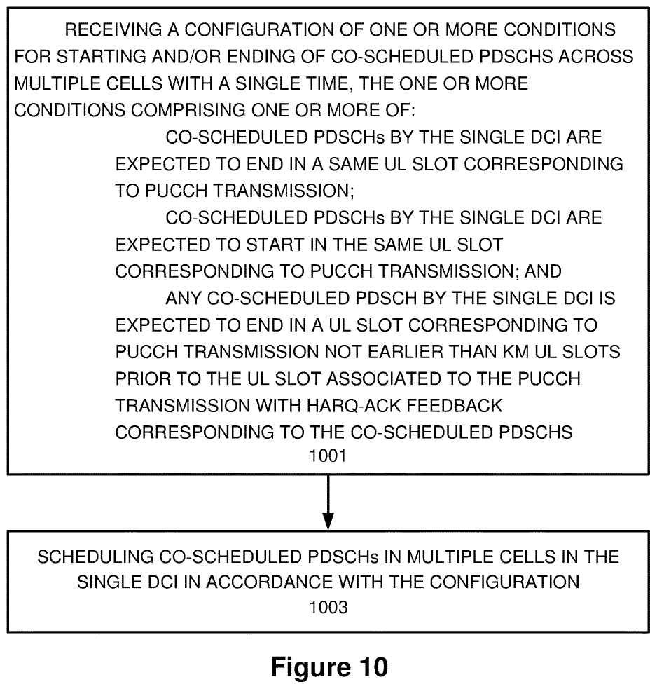

Operations of the network node 2000 (implemented using the structure of FIG. 20) will now be discussed with reference to the flow chart of FIG. 10 according to some embodiments of inventive concepts. For example, modules may be stored in memory 2004 of FIG. 20, and these modules may provide instructions so that when the instructions of a module are executed by respective network node processing circuitry 2002, the network node 2000 performs respective operations of the flow chart.

In some embodiments, the starting and/or ending of co-scheduled PDSCHs across multiple cells with a single time are expected to satisfy one or more or combination of the conditions listed below:
The co-scheduled PDSCHs by the single DCI are expected to end in the same UL slot corresponding to PUCCH transmission.
The co-scheduled PDSCHs by the single DCI are expected to start in the same UL slot corresponding to PUCCH transmission.
Any co-scheduled PDSCH by the single DCI is expected to end in a UL slot corresponding to PUCCH transmission not earlier than Km UL slots prior to the UL slot associated to the PUCCH transmission with HARQ-ACK feedback corresponding to the co-scheduled PDSCHs.

FIG. 10 illustrates operations the network node 2000 performs in some of the above embodiments. Turning to FIG. 10, in block 1001, the network node 2000 receives a configuration of one or more conditions for starting and/or ending of co-scheduled physical downlink shared channels, PDSCHs, across multiple cells with a single DCI, the one or more conditions comprising one or more of: co-scheduled PDSCHs by the single DCI are expected to end in a same uplink, UL, slot corresponding to physical uplink control channel, PUCCH, transmission: co-scheduled PDSCHs by the single DCI are expected to start in the same UL slot corresponding to PUCCH transmission; and any co-scheduled PDSCH by the single DCI is expected to end in a UL slot corresponding to physical uplink control channel, PUCCH, transmission not earlier than Km UL slots prior to the UL slot associated to the PUCCH transmission with hybrid automatic repeat request-acknowledgement, HARQ-ACK, feedback corresponding to the co-scheduled PDSCHs.

In block 1003, the network node schedules co-scheduled PDSCHs in multiple cells in the single DCI in accordance with the configuration.
In one example, Km is the maximum K1 value configured or available by default to the UE for PUCCH transmission with HARQ-ACK.
In one example Km is provided by configuration.
In one example Km is provided by configuration and is limited to maximum K1 value.

In other embodiments, the set of K1 values is configured or available by default. This set is extended for the purpose of determining the set of M_{A,c} candidate PDSCH reception occasions for a cell c among the configured cells for single DCI scheduling multiple cells for Type-1 HARQ-ACK codebook. For timing of HARQ-ACK feedback transmission, the DCI indicates a value from the set K₁.

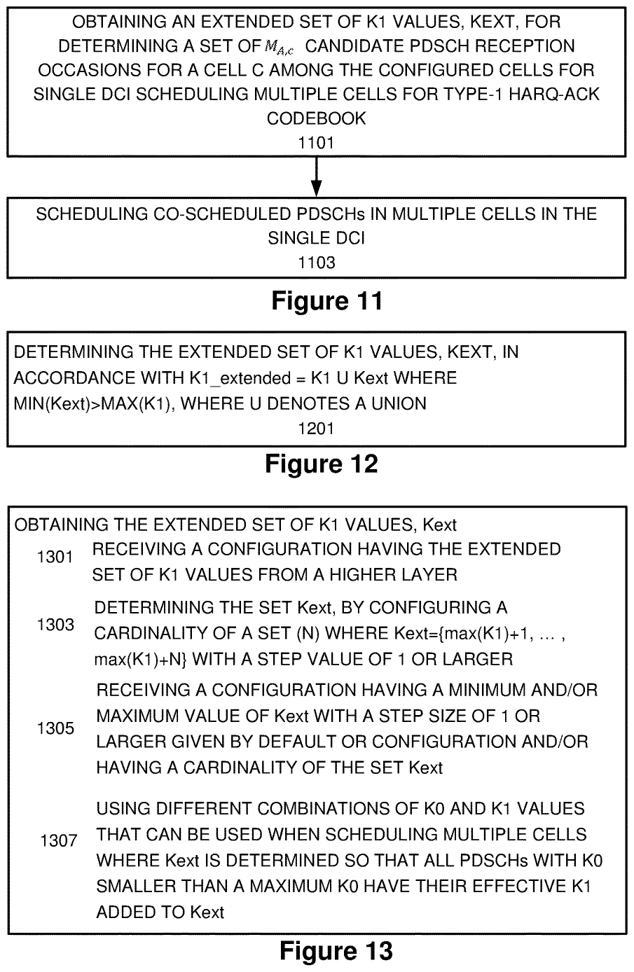

FIG. 11 illustrates operations the network node 2000 performs in some of the above embodiments. Turning to FIG. 11, in block 1101, the network node 2000 obtains an extended set of K1 values, Kext, for determining a set of M_{A,c} candidate physical downlink shared channel, PDSCH, reception occasions for a cell c among the configured cells for single DCI scheduling multiple cells for Type-1 hybrid automatic repeat request-acknowledgement, HARQ-ACK, codebook. In block 1103, the network node 2000 schedules co-scheduled PDSCHs in multiple cells in the single DC.

The extended K1 set is determined such that:
K1_extended=K1_U Kext where min (Kext)>max (K1), where U denotes the union.
One or more methods below or their combinations describe determination of the set Kext
   In one example as illustrated in block 1301 of FIG. 13, the network node 22—receives a configuration having the extended set Kext of K1 values from a higher layer.
   In one example as illustrated in block 1303 of FIG. 13, the network node 2200 determines the extended set of K1 values Kext by configuring the cardinality of the set (N) where Kext={max (K1)+1, . . . , max (K1)+N} assuming step value of 1 or larger (given by default or configuration).
   In one example as illustrated in block 1305 of FIG. 13, the network node 2000 determines the extended set Kext, by configuring the minimum and/or maximum value of Kext assuming a step size of 1 or larger (given by default or configuration), and/or providing the cardinality of the set (Kext).
   In one example as illustrated in block 1307 of FIG. 13, the network node 2000 determines the extend set Kext using the different combinations of K0 and K1 values that can be used when scheduling multiple cells. The set is determined so that all PDSCHs with K0 smaller than the maximum K0 have their effective K1 (meaning the number of slots between the PDSCH and the slot in which the PDCCH is transmitted) added to Kext. For example, let the set of possible K0 combinations be {(K0₀, K0₁, . . . , K0ₙ)₀, (K0₀, K0₁, . . . , K0ₙ)₁, . . . (K0₀, K0₁, . . . , K0ₙ)ₘ}. The possible K0 combinations can be calculated from the TDRA entries that are possible to schedule together. For a certain combination (K0₀, K0₁, . . . , K0ₙ); and a certain K1 the values K0_{0j,max}−K0ᵢ+K1 are put into the set Kext. In the example in FIG. 7, we have a combination of K0s as (K0₀, K0₁)=(1,2) and K1=7. From this combination of K0s and K1 we have K0ₘₐₓ=2, so we add 2−1+7=8 and 2−2+7=7 to the set Kext. Kext will contain the numbers 7, 8 from this combination. This is repeated for all other possible K0 combinations and K1 values. In some versions we do not add a number to Kext if it already exists in the K1 set.
In some versions of this embodiment, the number of repetitions is also taken into account. Then instead of calculating the maximum of K0 as K0ₘₐₓ, the maximum of K0+Nᵣₑₚ−1 is calculated for the entry in the TDRA table. Here Nᵣₑₚ is the number of repetitions of the PDSCH.

In another embodiment, when a single DCI schedules multiple PDSCHs across cells, the HARQ-ACK information corresponding to the co-scheduled PDSCHs is transmitted in a PUCCH in UL slot nᵤ. For every scheduled cell c, the co-scheduled PDSCH (or its repetition) that ends in a UL slot n_{e,c} such that nᵤ−n_{e,c}>max (K1) is determined. This PDSCH is called an outer PDSCH for cell c for simplifying the description herein below.

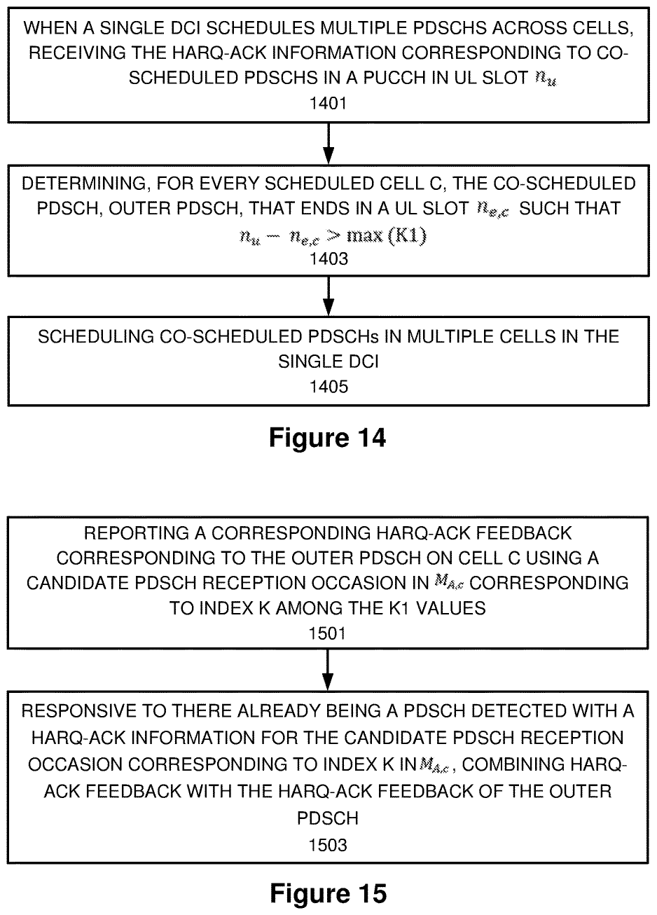

FIG. 14 illustrates operations the network node 2000 performs in the above embodiment. Turning to FIG. 14, in block 1401, the network node 1200, when a single DCI schedules multiple physical downlink shared channels, PDSCHs, across cells, receives the hybrid automatic repeat request-acknowledgement, HARQ-ACK, information corresponding to co-scheduled PDSCHs in a physical uplink control channel, PUCCH, in UL slot nᵤ. In block 1403, the network node 2200 determines, for every scheduled cell c, the co-scheduled PDSCH, outer PDSCH, that ends in a UL slot n_{e,c} such that nᵤ−n_{e,c}>max (K1). In block 1405, the network node 2000 schedules co-scheduled PDSCHs in multiple cells in the single DCI.
The candidate PDSCH reception occasion in M_{A,c} corresponding to index k among the K1 values is used instead for reporting the corresponding HARQ-ACK feedback corresponding to the outer PDSCH on cell c. Thus, as illustrated in block 1501 of FIG. 15, the network node 2000 reports a corresponding HARQ-ACK feedback corresponding to the outer PDSCH on cell c using a candidate PDSCH reception occasion in M_(A,c) corresponding to index k among the K1 values.
If there is already a PDSCH detected with a HARQ-ACK information for the candidate PDSCH reception occasion corresponding to index k in M_{A,c}, this HARQ-ACK feedback can be combined with the HARQ-ACK feedback of the outer PDSCH, for example by bundling, to form the HARQ-ACK feedback corresponding to the PDSCH reception occasion in M_{A,c} associated to index k. Thus, as illustrated in block 1503 of FIG. 15, the network node 2000, responsive to there already being a PDSCH detected with a HARQ-ACK information for the candidate PDSCH reception occasion corresponding to index k in M_(A,c), combines HARQ-ACK feedback with the HARQ-ACK feedback of the outer PDSCH.
The value k in the set L1 for the cell c can be determined implicitly or explicitly. For example, the smallest or the largest value in set K₁, or configured.
The value of k can correspond to an occasion with no corresponding PDSCH received and hence NACK in the corresponding occasion in M_{A,c}. The occasion can be determined based on a rule, for example the first available one, or the last available one.

In another embodiment, the HARQ-ACK feedback for the outer PDSCHs across cells can be collected in a set. The collection follows an order. For example, the ordering in the set can be by increasing order of the serving cell index first and/or time next.
The set of HARQ-ACK feedbacks for the outer PDSCHs can be appended to the Type-1 HARQ-ACK feedback codebook.

The set of HARQ-ACK feedbacks for the outer PDSCHs can be combined (for example bundled) and appended to the Type-1 HARQ-ACK feedback codebook. In case a co-scheduled PDSCH is repeated, the last repetition of the PDSCH is considered in the embodiments above.

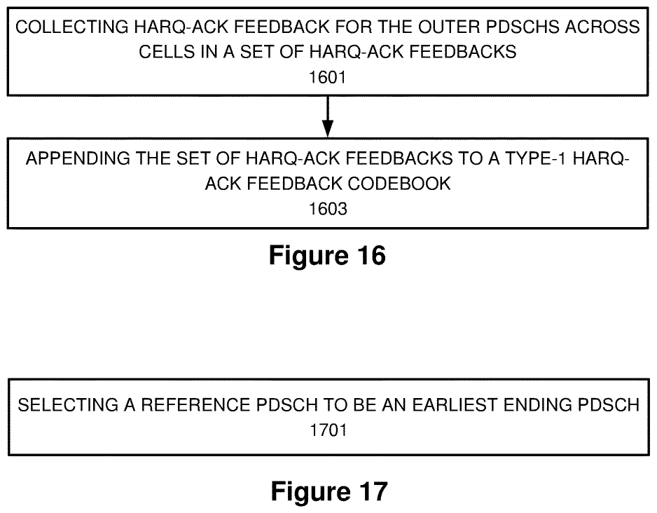

FIG. 16 illustrates operations the network node 2000 performs in the above embodiment. Turning to FIG. 16, in block 1601, the network node 200 collects HARQ-ACK feedback for the outer PDSCHs across cells in a set of HARQ-ACK feedbacks. In block 1603, the network node 2000 appends the set of HARQ-ACK feedbacks to a Type-1 HARQ-ACK feedback codebook.

In another example, the reference PDSCH is selected to be the earliest ending PDSCH. In case repetitions are used, the reference PDSCH is selected from the final repetitions taking all scheduled cells into account. In FIG. 8, the candidate PDSCH is the second repetition of PDSCH1, and the only repetition of PDSCH2. The last repetition of PDSCH2 ends in an earlier slot, PDSCH2 is the reference PDSCH. Thus, as illustrated in block 1701 of FIG. 17, the network node 2000 selects a reference PDSCH to be an earliest ending PDSCH.

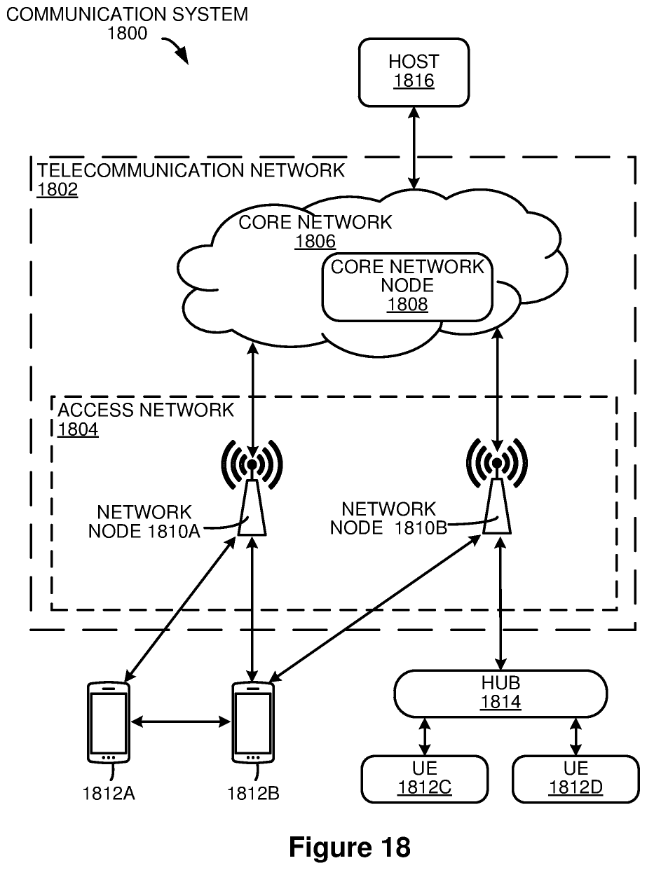

FIG. 18 shows an example of a communication system 1800 in accordance with some embodiments.

In the example, the communication system 1800 includes a telecommunication network 1802 that includes an access network 1804, such as a radio access network (RAN), and a core network 1806, which includes one or more core network nodes 1808. The access network 1804 includes one or more access network nodes, such as network nodes 1810A and 1810B (one or more of which may be generally referred to as network nodes 1810), or any other similar 3^{rd} Generation Partnership Project (3GPP) access node or non-3GPP access point. The network nodes 1810 facilitate direct or indirect connection of user equipment (UE), such as by connecting UEs 1812A, 1812B, 1812C, and 1812D (one or more of which may be generally referred to as UEs 1812) to the core network 1806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1800 may include any number of wired or wireless networks, network nodes, UEs, and/or any other components or systems that may facilitate or participate in the communication of data and/or signals whether via wired or wireless connections. The communication system 1800 may include and/or interface with any type of communication, telecommunication, data, cellular, radio network, and/or other similar type of system.

The UEs 1812 may be any of a wide variety of communication devices, including wireless devices arranged, configured, and/or operable to communicate wirelessly with the network nodes 1810 and other communication devices. Similarly, the network nodes 1810 are arranged, capable, configured, and/or operable to communicate directly or indirectly with the UEs 1812 and/or with other network nodes or equipment in the telecommunication network 1802 to enable and/or provide network access, such as wireless network access, and/or to perform other functions, such as administration in the telecommunication network 1802.

In the depicted example, the core network 1806 connects the network nodes 1810 to one or more hosts, such as host 1816. These connections may be direct or indirect via one or more intermediary networks or devices. In other examples, network nodes may be directly coupled to hosts. The core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of the core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1816 may be under the ownership or control of a service provider other than an operator or provider of the access network 1804 and/or the telecommunication network 1802, and may be operated by the service provider or on behalf of the service provider. The host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1800 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth. Z-Wave. Near Field Communication (NFC) ZigBee. LiFi (Light Fidelity), and/or any low-power wide-area network (LPWAN) standards such as LoRa (Long Range) and Sigfox.

In some examples, the telecommunication network 1802 is a cellular network that implements 3GPP standardized features. Accordingly, the telecommunications network 1802 may support network slicing to provide different logical networks to different devices that are connected to the telecommunication network 1802. For example, the telecommunications network 1802 may provide Ultra Reliable Low Latency Communication (URLLC) services to some UEs, while providing Enhanced Mobile Broadband (eMBB) services to other UEs. and/or Massive Machine Type Communication (mMTC)/Massive IoT (Internet of Things) services to yet further UEs.

In some examples, the UEs 1812 are configured to transmit and/or receive information without direct human interaction. For instance, a UE may be designed to transmit information to the access network 1804 on a predetermined schedule, when triggered by an internal or external event, or in response to requests from the access network 1804. Additionally, a UE may be configured for operating in single- or multi-RAT or multi-standard mode. For example, a UE may operate with any one or combination of Wi-Fi. NR (New Radio) and LTE. i.e., being configured for multi-radio dual connectivity (MR-DC), such as E-UTRAN (Evolved-UMTS Terrestrial Radio Access Network) New Radio-Dual Connectivity (EN-DC).

In the example, the hub 1814 communicates with the access network 1804 to facilitate indirect communication between one or more UEs (e.g., UE 1812C and/or 1812D) and network nodes (e.g., network node 1810B). In some examples, the hub 1814 may be a controller, router, content source and analytics, or any of the other communication devices described herein regarding UEs. For example, the hub 1814 may be a broadband router enabling access to the core network 1806 for the UEs. As another example, the hub 1814 may be a controller that sends commands or instructions to one or more actuators in the UEs. Commands or instructions may be received from the UEs, network nodes 1810, or by executable code, script, process, or other instructions in the hub 1814. As another example, the hub 1814 may be a data collector that acts as temporary storage for UE data and, in some embodiments, may perform analysis or other processing of the data. As another example, the hub 1814 may be a content source. For example, for a UE that is a VR headset, display, loudspeaker or other media delivery device, the hub 1814 may retrieve VR assets, video, audio, or other media or data related to sensory information via a network node, which the hub 1814 then provides to the UE either directly, after performing local processing, and/or after adding additional local content. In still another example, the hub 1814 acts as a proxy server or orchestrator for the UEs, in particular in if one or more of the UEs are low energy IoT devices.

The hub 1814 may have a constant/persistent or intermittent connection to the network node 1810B. The hub 1814 may also allow for a different communication scheme and/or schedule between the hub 1814 and UEs (e.g., UE 1812C and/or 1812D), and between the hub 1814 and the core network 1806. In other examples, the hub 1814 is connected to the core network 1806 and/or one or more UEs via a wired connection. Moreover, the hub 1814 may be configured to connect to an M2M service provider over the access network 1804 and/or to another UE over a direct connection. In some scenarios, UEs may establish a wireless connection with the network nodes 1810 while still connected via the hub 1814 via a wired or wireless connection. In some embodiments, the hub 1814 may be a dedicated hub—that is, a hub whose primary function is to route communications to/from the UEs from/to the network node 1810B. In other embodiments, the hub 1814 may be a non-dedicated hub—that is, a device which is capable of operating to route communications between the UEs and network node 1810B, but which is additionally capable of operating as a communication start and/or end point for certain data channels.

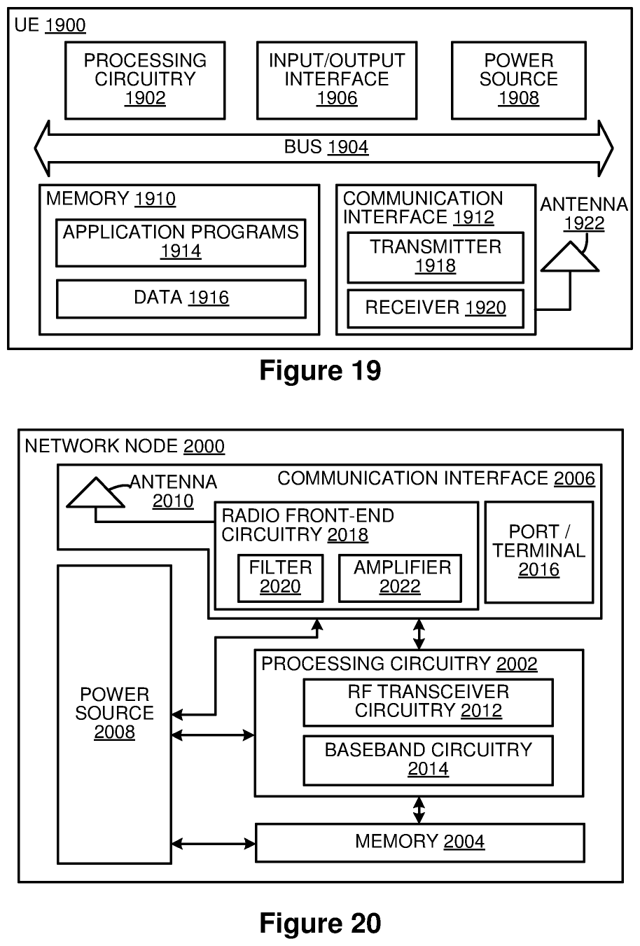

FIG. 19 shows a UE 1900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1900 includes processing circuitry 1902 that is operatively coupled via a bus 1904 to an input/output interface 1906, a power source 1908, a memory 1910, a communication interface 1912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry 1902 is configured to process instructions and data and may be configured to implement any sequential state machine operative to execute instructions stored as machine-readable computer programs in the memory 1910. The processing circuitry 1902 may be implemented as one or more hardware-implemented state machines (e.g., in discrete logic, field-programmable gate arrays (FPGAs), application specific integrated circuits (ASICs), etc.); programmable logic together with appropriate firmware: one or more stored computer programs, general-purpose processors, such as a microprocessor or digital signal processor (DSP), together with appropriate software: or any combination of the above. For example, the processing circuitry 1902 may include multiple central processing units (CPUs).

In the example, the input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1908 is structured as a battery or battery pack. Other types of power sources, such as an external power source (e.g., an electricity outlet), photovoltaic device, or power cell, may be used. The power source 1908 may further include power circuitry for delivering power from the power source 1908 itself, and/or an external power source, to the various parts of the UE 1900 via input circuitry or an interface such as an electrical power cable. Delivering power may be, for example, for charging of the power source 1908. Power circuitry may perform any formatting, converting, or other modification to the power from the power source 1908 to make the power suitable for the respective components of the UE 1900 to which power is supplied.

The memory 1910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1910 includes one or more application programs 1914, such as an operating system, web browser application, a widget, gadget engine, or other application, and corresponding data 1916. The memory 1910 may store, for use by the UE 1900, any of a variety of various operating systems or combinations of operating systems.

The memory 1910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1910 may allow the UE 1900 to access instructions, application programs and the like, stored on transitory or non-transitory memory media, to off-load data, or to upload data. An article of manufacture, such as one utilizing a communication system may be tangibly embodied as or in the memory 1910, which may be or comprise a device-readable storage medium.

The processing circuitry 1902 may be configured to communicate with an access network or other network using the communication interface 1912. The communication interface 1912 may comprise one or more communication subsystems and may include or be communicatively coupled to an antenna 1922. The communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, the transmitter 1918 and receiver 1920 may be coupled to one or more antennas (e.g., antenna 1922) and may share circuit components, software or firmware, or alternatively be implemented separately.

In the illustrated embodiment, communication functions of the communication interface 1912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1900 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 20 shows a network node 2000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations. Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs). Operation and Maintenance (O&M) nodes. Operations Support System (OSS) nodes. Self-Organizing Network (SON) nodes, positioning nodes (e.g., Evolved Serving Mobile Location Centers (E-SMLCs)), and/or Minimization of Drive Tests (MDTs).

The network node 2000 includes a processing circuitry 2002, a memory 2004, a communication interface 2006, and a power source 2008. The network node 2000 may be composed of multiple physically separate components (e.g., a NodeB component and a RNC component, or a BTS component and a BSC component, etc.), which may each have their own respective components. In certain scenarios in which the network node 2000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2000 may be configured to support multiple radio access technologies (RATs). In such embodiments, some components may be duplicated (e.g., separate memory 2004 for different RATs) and some components may be reused (e.g., a same antenna 2010 may be shared by different RATs). The network node 2000 may also include multiple sets of the various illustrated components for different wireless technologies integrated into network node 2000, for example GSM. WCDMA. LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2000.

The processing circuitry 2002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2000 components, such as the memory 2004, to provide network node 2000 functionality.

In some embodiments, the processing circuitry 2002 includes a system on a chip (SOC). In some embodiments, the processing circuitry 2002 includes one or more of radio frequency (RF) transceiver circuitry 2012 and baseband processing circuitry 2014. In some embodiments, the radio frequency (RF) transceiver circuitry 2012 and the baseband processing circuitry 2014 may be on separate chips (or sets of chips), boards, or units, such as radio units and digital units. In alternative embodiments, part or all of RF transceiver circuitry 2012 and baseband processing circuitry 2014 may be on the same chip or set of chips, boards, or units.

The memory 2004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and memory 2004 is integrated. The communication interface 2006 is used in wired or wireless communication of signaling and/or data between a network node, access network, and/or UE. As illustrated, the communication interface 2006 comprises port(s)/terminal(s) 2016 to send and receive data, for example to and from a network over a wired connection. The communication interface 2006 also includes radio front-end circuitry 2018 that may be coupled to, or in certain embodiments a part of, the antenna 2010. Radio front-end circuitry 2018 comprises filters 2020 and amplifiers 2022. The radio front-end circuitry 2018 may be connected to an antenna 2010 and processing circuitry 2002. The radio front-end circuitry may be configured to condition signals communicated between antenna 2010 and processing circuitry 2002. The radio front-end circuitry 2018 may receive digital data that is to be sent out to other network nodes or UEs via a wireless connection. The radio front-end circuitry 2018 may convert the digital data into a radio signal having the appropriate channel and bandwidth parameters using a combination of filters 2020 and/or amplifiers 2022. The radio signal may then be transmitted via the antenna 2010. Similarly, when receiving data, the antenna 2010 may collect radio signals which are then converted into digital data by the radio front-end circuitry 2018. The digital data may be passed to the processing circuitry 2002. In other embodiments, the communication interface may comprise different components and/or different combinations of components.

In certain alternative embodiments, the network node 2000 does not include separate radio front-end circuitry 2018, instead, the processing circuitry 2002 includes radio front-end circuitry and is connected to the antenna 2010. Similarly, in some embodiments, all or some of the RF transceiver circuitry 2012 is part of the communication interface 2006. In still other embodiments, the communication interface 2006 includes one or more ports or terminals 2016, the radio front-end circuitry 2018, and the RF transceiver circuitry 2012, as part of a radio unit (not shown), and the communication interface 2006 communicates with the baseband processing circuitry 2014, which is part of a digital unit (not shown).

The antenna 2010 may include one or more antennas, or antenna arrays, configured to send and/or receive wireless signals. The antenna 2010 may be coupled to the radio front-end circuitry 2018 and may be any type of antenna capable of transmitting and receiving data and/or signals wirelessly. In certain embodiments, the antenna 2010 is separate from the network node 2000 and connectable to the network node 2000 through an interface or port.

The antenna 2010, communication interface 2006, and/or the processing circuitry 2002 may be configured to perform any receiving operations and/or certain obtaining operations described herein as being performed by the network node. Any information, data and/or signals may be received from a UE, another network node and/or any other network equipment. Similarly, the antenna 2010, the communication interface 2006, and/or the processing circuitry 2002 may be configured to perform any transmitting operations described herein as being performed by the network node. Any information, data and/or signals may be transmitted to a UE, another network node and/or any other network equipment.

The power source 2008 provides power to the various components of network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid, an electricity outlet) via an input circuitry or interface such as an electrical cable, whereby the external power source supplies power to power circuitry of the power source 2008. As a further example, the power source 2008 may comprise a source of power in the form of a battery or battery pack which is connected to, or integrated in, power circuitry. The battery may provide backup power should the external power source fail.

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000.

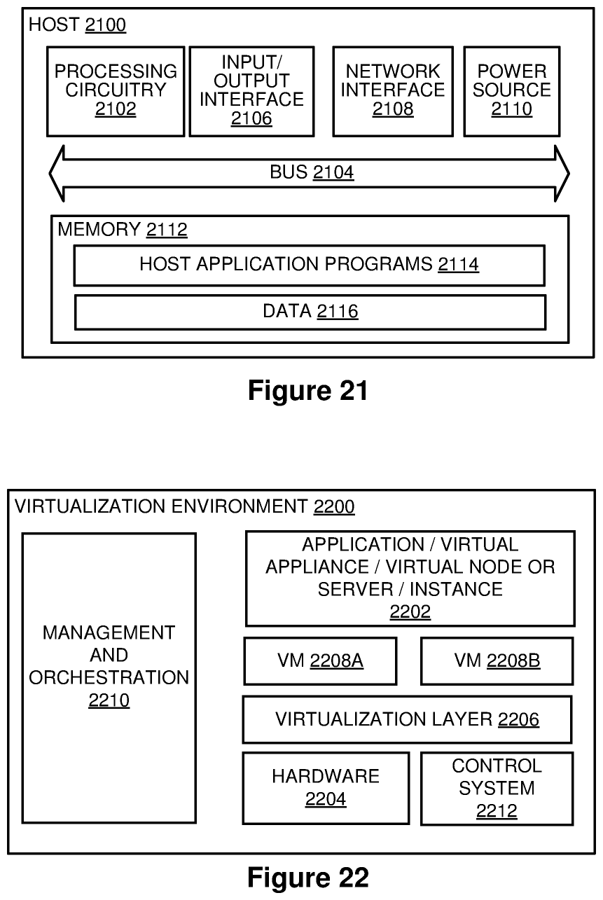

FIG. 21 is a block diagram of a host 2100, which may be an embodiment of the host 1816 of FIG. 18, in accordance with various aspects described herein. As used herein, the host 2100 may be or comprise various combinations hardware and/or software, including a standalone server, a blade server, a cloud-implemented server, a distributed server, a virtual machine, container, or processing resources in a server farm. The host 2100 may provide one or more services to one or more UEs.

The host 2100 includes processing circuitry 2102 that is operatively coupled via a bus 2104 to an input/output interface 2106, a network interface 2108, a power source 2110, and a memory 2112. Other components may be included in other embodiments. Features of these components may be substantially similar to those described with respect to the devices of previous figures, such as FIGS. 19 and 20, such that the descriptions thereof are generally applicable to the corresponding components of host 2100.

The memory 2112 may include one or more computer programs including one or more host application programs 2114 and data 2116, which may include user data, e.g., data generated by a UE for the host 2100 or data generated by the host 2100 for a UE. Embodiments of the host 2100 may utilize only a subset or all of the components shown. The host application programs 2114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2114 may also provide for user authentication and licensing checks and may periodically report health, routes, and content availability to a central node, such as a device in or on the edge of a core network. Accordingly, the host 2100 may select and/or indicate a different host for over-the-top services for a UE. The host application programs 2114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 22 is a block diagram illustrating a virtualization environment 2200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2202 (which may alternatively be called software instances, virtual appliances, network functions, virtual nodes, virtual network functions, etc.) are run in the virtualization environment 2200 to implement some of the features, functions, and/or benefits of some of the embodiments disclosed herein.

Hardware 2204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2206 (also referred to as hypervisors or virtual machine monitors (VMMs)), provide VMs 2208A and 2208B (one or more of which may be generally referred to as VMs 2208), and/or perform any of the functions, features and/or benefits described in relation with some embodiments described herein. The virtualization layer 2206 may present a virtual operating platform that appears like networking hardware to the VMs 2208.

The VMs 2208 comprise virtual processing, virtual memory, virtual networking or interface and virtual storage, and may be run by a corresponding virtualization layer 2206. Different embodiments of the instance of a virtual appliance 2202 may be implemented on one or more of VMs 2208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2208 may be a software implementation of a physical machine that runs programs as if they were executing on a physical, non-virtualized machine. Each of the VMs 2208, and that part of hardware 2204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2208 on top of the hardware 2204 and corresponds to the application 2202.

Hardware 2204 may be implemented in a standalone network node with generic or specific components. Hardware 2204 may implement some functions via virtualization. Alternatively, hardware 2204 may be part of a larger cluster of hardware (e.g., such as in a data center or CPE) where many hardware nodes work together and are managed via management and orchestration 2210, which, among others, oversees lifecycle management of applications 2202. In some embodiments, hardware 2204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2212 which may alternatively be used for communication between hardware nodes and radio units.

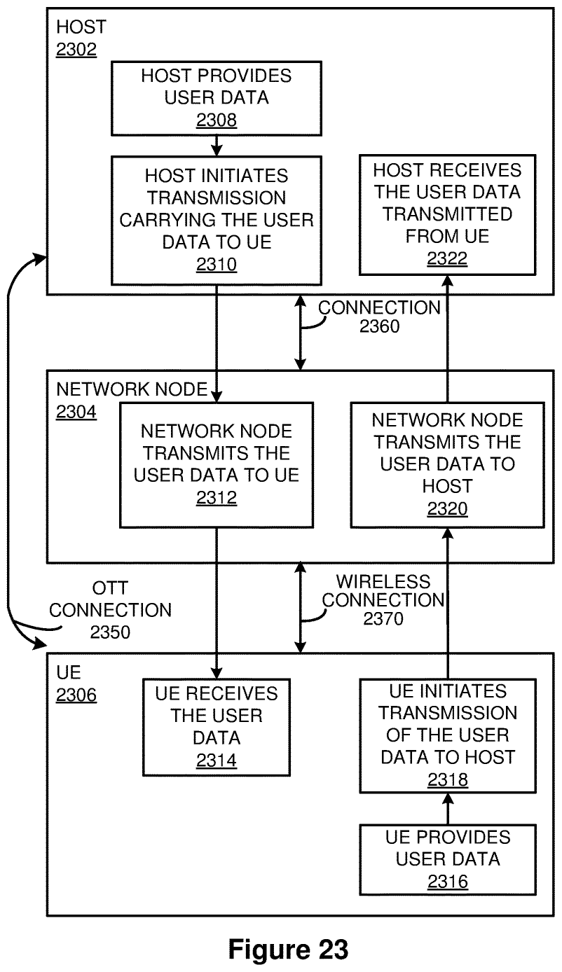

FIG. 23 shows a communication diagram of a host 2302 communicating via a network node 2304 with a UE 2306 over a partially wireless connection in accordance with some embodiments. Example implementations, in accordance with various embodiments, of the UE (such as a UE 1812A of FIG. 18 and/or UE 1900 of FIG. 19), network node (such as network node 1810A of FIG. 18 and/or network node 2000 of FIG. 20), and host (such as host 1816 of FIG. 18 and/or host 2100 of FIG. 21) discussed in the preceding paragraphs will now be described with reference to FIG. 23.

Like host 2100, embodiments of host 2302 include hardware, such as a communication interface, processing circuitry, and memory. The host 2302 also includes software, which is stored in or accessible by the host 2302 and executable by the processing circuitry. The software includes a host application that may be operable to provide a service to a remote user, such as the UE 2306 connecting via an over-the-top (OTT) connection 2350) extending between the UE 2306 and host 2302. In providing the service to the remote user, a host application may provide user data which is transmitted using the OTT connection 2350.

The network node 2304 includes hardware enabling it to communicate with the host 2302 and UE 2306. The connection 2360 may be direct or pass through a core network (like core network 1806 of FIG. 18) and/or one or more other intermediate networks, such as one or more public, private, or hosted networks. For example, an intermediate network may be a backbone network or the Internet.

The UE 2306 includes hardware and software, which is stored in or accessible by UE 2306 and executable by the UE's processing circuitry. The software includes a client application, such as a web browser or operator-specific “app” that may be operable to provide a service to a human or non-human user via UE 2306 with the support of the host 2302. In the host 2302, an executing host application may communicate with the executing client application via the OTT connection 2350 terminating at the UE 2306 and host 2302. In providing the service to the user, the UE's client application may receive request data from the host's host application and provide user data in response to the request data. The OTT connection 2350 may transfer both the request data and the user data. The UE's client application may interact with the user to generate the user data that it provides to the host application through the OTT connection 2350.

The OTT connection 2350 may extend via a connection 2360 between the host 2302 and the network node 2304 and via a wireless connection 2370 between the network node 2304 and the UE 2306 to provide the connection between the host 2302 and the UE 2306. The connection 2360) and wireless connection 2370, over which the OTT connection 2350 may be provided, have been drawn abstractly to illustrate the communication between the host 2302 and the UE 2306 via the network node 2304, without explicit reference to any intermediary devices and the precise routing of messages via these devices.

As an example of transmitting data via the OTT connection 2350, in step 2308, the host 2302 provides user data, which may be performed by executing a host application. In some embodiments, the user data is associated with a particular human user interacting with the UE 2306. In other embodiments, the user data is associated with a UE 2306 that shares data with the host 2302 without explicit human interaction. In step 2310, the host 2302 initiates a transmission carrying the user data towards the UE 2306. The host 2302 may initiate the transmission responsive to a request transmitted by the UE 2306. The request may be caused by human interaction with the UE 2306 or by operation of the client application executing on the UE 2306. The transmission may pass via the network node 2304, in accordance with the teachings of the embodiments described throughout this disclosure. Accordingly, in step 2312, the network node 2304 transmits to the UE 2306 the user data that was carried in the transmission that the host 2302 initiated, in accordance with the teachings of the embodiments described throughout this disclosure. In step 2314, the UE 2306 receives the user data carried in the transmission, which may be performed by a client application executed on the UE 2306 associated with the host application executed by the host 2302.

In some examples, the UE 2306 executes a client application which provides user data to the host 2302. The user data may be provided in reaction or response to the data received from the host 2302. Accordingly, in step 2316, the UE 2306 may provide user data, which may be performed by executing the client application. In providing the user data, the client application may further consider user input received from the user via an input/output interface of the UE 2306. Regardless of the specific manner in which the user data was provided, the UE 2306 initiates, in step 2318, transmission of the user data towards the host 2302 via the network node 2304. In step 2320, in accordance with the teachings of the embodiments described throughout this disclosure, the network node 2304 receives user data from the UE 2306 and initiates transmission of the received user data towards the host 2302. In step 2322, the host 2302 receives the user data carried in the transmission initiated by the UE 2306.

In an example scenario, factory status information may be collected and analyzed by the host 2302. As another example, the host 2302 may process audio and video data which may have been retrieved from a UE for use in creating maps. As another example, the host 2302 may collect and analyze real-time data to assist in controlling vehicle congestion (e.g., controlling traffic lights). As another example, the host 2302 may store surveillance video uploaded by a UE. As another example, the host 2302 may store or control access to media content such as video, audio, VR or AR which it can broadcast, multicast or unicast to UEs. As other examples, the host 2302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2350 between the host 2302 and UE 2306, in response to variations in the measurement results. The measurement procedure and/or the network functionality for reconfiguring the OTT connection may be implemented in software and hardware of the host 2302 and/or UE 2306. In some embodiments, sensors (not shown) may be deployed in or in association with other devices through which the OTT connection 2350 passes: the sensors may participate in the measurement procedure by supplying values of the monitored quantities exemplified above, or supplying values of other physical quantities from which software may compute or estimate the monitored quantities. The reconfiguring of the OTT connection 2350 may include message format, retransmission settings, preferred routing etc.: the reconfiguring need not directly alter the operation of the network node 2304. Such procedures and functionalities may be known and practiced in the art. In certain embodiments, measurements may involve proprietary UE signaling that facilitates measurements of throughput, propagation times, latency and the like, by the host 2302. The measurements may be implemented in that software causes messages to be transmitted, in particular empty or ‘dummy’ messages, using the OTT connection 2350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

1. A method in a network node to schedule multiple cells in a single downlink control information, DCI, the method comprising:
receiving a configuration of one or more conditions for starting and/or ending of co-scheduled physical downlink shared channels, PDSCHs, across multiple cells with a single time, the one or more conditions comprising one or more of:
co-scheduled PDSCHs by the single DCI are expected to end in a same uplink, UL, slot corresponding to PUCCH transmission;
co-scheduled PDSCHs by the single DCI are expected to start in the same UL slot corresponding to physical uplink control channel, PUCCH, transmission; and
any co-scheduled PDSCH by the single DCI is expected to end in a UL slot corresponding to PUCCH transmission not earlier than Km UL slots prior to the UL slot associated to the PUCCH transmission with hybrid automatic repeat request-acknowledgement, HARQ-ACK, feedback corresponding to the co-scheduled PDSCHs; and
scheduling co-scheduled PDSCHs in multiple cells in the single DCI in accordance with the configuration.

2. The method of claim 1, wherein Km is a maximum K1 value configured or available by default to the UE for PUCCH transmission with HARQ-ACK.

3. The method of claim 1, wherein Km is provided by the configuration.

4. The method of claim 1, wherein Km is provided by the configuration and is limited to a maximum K1 value.

5. A method in a network node to schedule multiple cells in a single downlink control information, DCI, the method comprising:
obtaining an extended set of K1 values, Kext, for determining a set of M_{A,c} candidate physical downlink shared channel, PDSCH, reception occasions for a cell c among the configured cells for single DCI scheduling multiple cells for Type-1 hybrid automatic repeat request-acknowledgement, HARQ-ACK, codebook; and
scheduling co-scheduled PDSCHs in multiple cells in the single DCI.

6. The method of claim 5, further comprising determining the extended set of K1 values, Kext, in accordance with
K1_extended=K1 U Kext where min>max, where U denotes a union.

7. The method of claim 5, wherein obtaining the extended set of K1 values comprises receiving a configuration having the extended set of K1 values from a higher layer.

8. The method of claim 5, wherein obtaining the extended set of K1 values comprises determining the set Kext, by configuring a cardinality of a set where Kext={max(K1)+1, . . . , max(K1)+N} with a step value of 1 or larger.

9. The method of claim 5, wherein obtaining the extended set of K1 values, Kext, comprises receiving a configuration having a minimum and/or maximum value of Kext with a step size of 1 or larger given by default or configuration and/or having a cardinality of the set Kext.

10. The method of claim 5, wherein obtaining the extended set of K1 values, Kext, comprises using different combinations of K0 and K1 values that can be used when scheduling multiple cells where Kext is determined so that all PDSCHs with K0 smaller than a maximum K0 have their effective K1 added to Kext.

11. A method in a network node to schedule multiple cells in a single downlink control information, DCI, the method comprising:
when a single DCI schedules multiple physical downlink shared channels, PDSCHs, across cells, receiving the hybrid automatic repeat request-acknowledgement, HARQ-ACK, information corresponding to co-scheduled PDSCHs in a physical uplink control channel, PUCCH, in UL slot nᵤ;
determining, for every scheduled cell c, the co-scheduled PDSCH, outer PDSCH, that ends in a UL slot n_{e,c} such that nᵤ−n_{e,c}>max (K1); and
scheduling co-scheduled PDSCHs in multiple cells in the single DCI.

12. The method of claim 11, further comprising:
reporting a corresponding HARQ-ACK feedback corresponding to the outer PDSCH on cell c using a candidate PDSCH reception occasion in M_{A,c} corresponding to index k among the K1 values.

13. The method of claim 12, further comprising:
responsive to there already being a PDSCH detected with a HARQ-ACK information for the candidate PDSCH reception occasion corresponding to index k in M_{A,c}, combining HARQ-ACK feedback with the HARQ-ACK feedback of the outer PDSCH.

14. The method of claim 11, further comprising:
collecting HARQ-ACK feedback for the outer PDSCHs across cells in a set of HARQ-ACK feedbacks; and
appending the set of HARQ-ACK feedbacks to a Type-1 HARQ-ACK feedback codebook.

15. The method of claim 11, further comprising:
selecting a reference PDSCH to be an earliest ending PDSCH.

16. A network node configured to communicate with a base station, the network node comprising a radio interface and processing circuitry configured to perform the method of claim 1.

17. A method implemented by a host configured to operate in a communication system that further includes a network node, and a user equipment, UE, the method comprising:
providing user data for the UE; and
initiating transmissions carrying the user data to the UE via a cellular network comprising the network node, wherein the network node performs the method of claim 1 to transmit the user data from the host to the UE.

18. A host configured to operate in a communication system to provide an over-the-top, OTT, service, the host comprising:
processing circuitry configured to provide user data; and
a network interface configured to initiate transmissions of the user data to a network node in a cellular network for transmission to user equipments, UEs, the network node having a communication interface and processing circuitry, the processing circuitry of the network node configured to perform the method of claim 1 to transmit the user data from the host to the UE.
